(19) United States
(12) Patent Application Publication
(10) Pub. No.: US 2024/0248464 A1
(43) Pub. Date: Jul. 25, 2024

(54) DEFECT PREDICTION SYSTEM, DEFECT PREDICTION METHOD, AND PROGRAM

(71) Applicant: Panasonic Intellectual Property Management Co., Ltd., Osaka (JP)

(72) Inventors: Jeffry NAINGGOLAN, Osaka (JP); Yuya SUGASAWA, Osaka (JP); Hisaji MURATA, Osaka (JP); Yoshinori SATOU, Osaka (JP)

(21) Appl. No.: 18/561,559

(22) PCT Filed: Mar. 15, 2022
(86) PCT No.: PCT/JP2022/011615

§ 371 Date: Nov. 16, 2023

(30) Foreign Application Priority Data
May 19, 2021 (JP) 2021-084847

(51) Int. Cl. G05B 19/418

(52) U.S. Cl. CPC G05B 19/41875; G05B 2219/32222

(57) ABSTRACT

A defect prediction system includes an acquirer, a defect-related number predictor, and a cause predictor. The defect-related number predictor predicts, based on a past defect-related number acquired by the acquirer, a future defect-related number of a product with respect to each of a plurality of production lines in each of a plurality of process steps. The cause predictor predicts, based on the future defect-related number predicted by the defect-related number predictor with respect to each of the plurality of production lines in each of the plurality of process steps, which of the plurality of production lines a cause of an increase in a total future defect-related number is attributable to.

### TECHNICAL FIELD

The present disclosure generally relates to a defect prediction system, a defect prediction method, and a program, and more particularly relates to a defect prediction system, a defect prediction method, and a program for use to make prediction about defects of a product.

### BACKGROUND ART

Patent Literature 1 discloses a known system for making a decision about defects of a product. More specifically, Patent Literature 1 discloses a system for determining a device to be a cause of defects (hereinafter referred to as “cause of defects determination system”). The system of Patent Literature 1 includes a factorial effect data creator, a factorial effect diagram plotter, a defective lot selection optimizer, and a device difference analyzer. The factorial effect data creator creates factorial effect data based on defective lot group information about a lot with a particular form of defects. The factorial effect diagram plotter plots a factorial effect diagram indicating whether the factorial effect data agrees with defective lot identification information. The defective lot selection optimizer selects, by reference to the factorial effect diagram, a plurality of defective lots that have become defective due to the same cause of defect. The device difference analyzer reads out, from a device history information database, the history information of a group of manufacturing devices that have processed the plurality of defective lots thus selected, thereby determining which manufacturing device has been used in common to process all of the plurality of defective lots.

When the cause of defects determination system of Patent Literature 1 finds the cause of an increase in the number of defects, however, the number of defects has already increased among the products. Thus, the cause of defects determination system of Patent Literature 1 involves an increase in the number of defects, which is a problem with the system of Patent Literature 1.

### CITATION LIST

### Patent Literature

Patent Literature 1: JP 2005-284650 A

### SUMMARY OF INVENTION

It is therefore an object of the present disclosure to provide a defect prediction system, a defect prediction method, and a program, all of which contribute to determining the cause of an increase in the number of defects before the number of defects increases among the products.

A defect prediction system according to an aspect of the present disclosure is configured to make prediction about defects that a product to be manufactured through a plurality of process steps is going to produce. Each of the plurality of process steps includes a plurality of production lines which are parallel with each other. The defect prediction system includes an acquirer, a defect-related number predictor, and a cause predictor. The acquirer acquires a past defect-related number with respect to each of the plurality of production lines in at least one of the plurality of process steps. The past defect-related number is related to a number of defects produced in the past to the product. The defect-related number predictor predicts, based on the past defect-related number acquired by the acquirer, a future defect-related number with respect to each of the plurality of production lines in each of the plurality of process steps. The future defect-related number is related to a future defect number that is a number of defects predicted to be produced in the future to the product. The cause predictor predicts, based on the future defect-related number predicted by the defect-related number predictor with respect to each of the plurality of production lines in each of the plurality of process steps, which of the plurality of production lines a cause of an increase in a total future defect-related number is attributable to. The total future defect-related number is a sum of the respective future defect-related numbers of the plurality of production lines.

A defect prediction method according to another aspect of the present disclosure is a method for making prediction about defects that a product to be manufactured through a plurality of process steps is going to produce. Each of the plurality of process steps includes a plurality of production lines which are parallel with each other. The defect prediction method includes an acquisition step, a defect-related number prediction step, and a cause prediction step. The acquisition step includes acquiring a past defect-related number with respect to each of the plurality of production lines in at least one of the plurality of process steps. The past defect-related number is related to a number of defects produced in the past to the product. The defect-related number prediction step includes predicting, based on the past defect-related number acquired in the acquisition step, a future defect-related number with respect to each of the plurality of production lines in each of the plurality of process steps. The future defect-related number is related to a future defect number that is a number of defects predicted to be produced in the future to the product. The cause prediction step includes predicting, based on the future defect-related number predicted in the defect-related number prediction step with respect to each of the plurality of production lines in each of the plurality of process steps, which of the plurality of production lines a cause of an increase in a total future defect-related number is attributable to. The total future defect-related number is a sum of the respective future defect-related numbers of the plurality of production lines.

A program according to still another aspect of the present disclosure is designed to cause one or more processors of a computer system to perform the defect prediction method described above.

### BRIEF DESCRIPTION OF DRAWINGS

FIG. 1 is a block diagram of a defect prediction system according to an exemplary embodiment;

FIG. 2 illustrates a manufacturing process of products to which the defect prediction system is applied;

FIG. 3 is a flowchart showing the procedure of processing to be performed by the defect prediction system;

FIG. 4 is a graph illustrating how the defect prediction system performs the processing;

FIGS. 5A-5D are graphs illustrating how the defect prediction system performs the processing; and

FIGS. 6A-6D are graphs illustrating how the defect prediction system performs the processing.

### DESCRIPTION OF EMBODIMENTS

A defect prediction system according to an exemplary embodiment will now be described with reference to the accompanying drawings. Note that the embodiment to be described below is only an exemplary one of various embodiments of the present disclosure and should not be construed as limiting. Rather, the exemplary embodiment may be readily modified in various manners depending on a design choice or any other factor without departing from the scope of the present disclosure.

### (Overview)

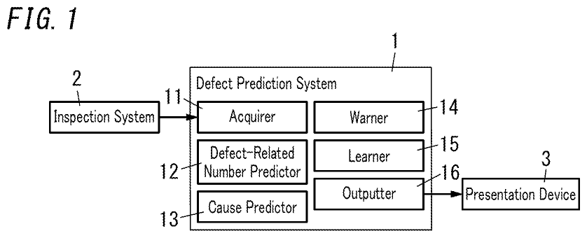

First, reference is made to FIG. 1. A defect prediction system 1 according to this embodiment makes prediction about defects that a product to be manufactured through a plurality of process steps is going to produce. Each of the plurality of process steps includes a plurality of production lines which are parallel with each other. The defect prediction system 1 includes an acquirer 11, a defect-related number predictor 12, and a cause predictor 13. The acquirer 11 acquires a past defect-related number of the product with respect to each of the plurality of production lines in at least one of the plurality of process steps. The defect-related number is a number related to the number of defects. The past defect-related number is related to the number of defects produced in the past to the product. The defect-related number predictor 12 predicts, based on the past defect-related number acquired by the acquirer 11, a future defect-related number with respect to each of the plurality of production lines in each of the plurality of process steps. The future defect-related number is related to the number of defects that are predicted to be produced in the future to the product. The cause predictor 13 predicts, based on the future defect-related number predicted by the defect-related number predictor 12 with respect to each of the plurality of production lines in each of the plurality of process steps, which of the plurality of production lines a cause of an increase in a total future defect-related number is attributable to. The total future defect-related number is the sum of the respective future defect-related numbers of the plurality of production lines.

The defect prediction system 1 according to this embodiment enables determining (predicting) the cause of an increase in the total defect-related number of products before the total defect-related number increases. This contributes to cutting down the total defect-related number of the products by eliminating the cause on an early stage.

As used herein, the “defect-related number” of a production line may refer to either the number of defective products (i.e., the number of defects) or the ratio of the number of defective products to the total number of products manufactured on a production line (i.e., a defect rate), whichever is appropriate.

Also, the expression “a plurality of production lines are parallel with each other” means that the results produced by the plurality of production lines are substantially the same and that the operation on any one of the plurality of production lines is completed without depending on the operation on any other production line. For example, the same operation may be performed on each of the plurality of production lines that are parallel with each other. When a product is supplied from one process step to a subsequent process step, the product may be supplied from any of the plurality of production lines of the one process step to any of the plurality of production lines of the subsequent process step.

### (Details)

### (1) Description of a Plurality of Process Steps and a Plurality of Production Lines

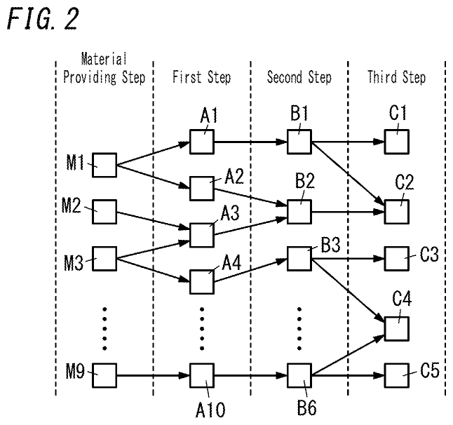

As shown in FIG. 2, the plurality of process steps according to this embodiment includes the process step of providing materials for a product (hereinafter referred to as a “material providing step”) and three process steps in which operations are performed to manufacture the product (hereinafter referred to as a “first step,” a “second step,” and a “third step,” respectively). The material providing step is the most upstream process step, the first step is downstream of the material providing step, the second step is downstream of the first step, and the third step is downstream of the second step.

The material providing step includes nine production lines M1-M9. The first step includes ten production lines A1-A10. The second step includes six production lines B1-B6. The third step includes five production lines C1-C5. Note that the number of the production lines included in each process step is only an example and should not be construed as limiting.

The same material is provided in each of the production lines M1-M9 of the material providing step. The production lines M1-M9 may be distinguished from each other by, for example, the lot numbers of the material. For example, supposing the first to ninth lot numbers are mutually different lot numbers, an it production line Mi (where i=1, 2, 3, . . . , or 9) is a process step of providing a material to which an i^{th} lot number is assigned.

The same operation is performed in each of the production lines A1-A10 of the first step. The production lines A1-A10 are each distinguished by, for example, either a device or system that performs the first step. That is to say, the same number of (i.e., ten) devices or systems (namely, first to tenth devices or systems) as that of the production lines A1-A10 are provided. A j^{th} production line Aj (where j=1, 2, 3, . . . , or 10) is a process step of performing the operation using a j^{th} device or system.

Likewise, the same operation is performed in each of the production lines B1-B6 of the second step. The production lines B1-B6 are each distinguished by, for example, either a device or system that performs the second step.

Likewise, the same operation is performed in each of the production lines C1-C5 of the third step. The production lines C1-C5 are each distinguished by, for example, either a device or system that performs the third step.

Examples of the devices or systems that perform the first to third steps include an operating member that performs an operation on the material (product), a motor for driving the operating member, a temperature adjustment mechanism for heating or cooling the material, a chemical treatment system for subjecting the material to chemical treatment, and a control mechanism for controlling the overall devices or systems.

In FIG. 2, the plurality of open squares indicate respective production lines. Also, each of the arrows shown in FIG. 2 indicates that a material (or a product) is supplied from a production line of an upstream process step at the nock of the arrow to a production line of a downstream process step at the head of the arrow.

The material provided in each of the production lines M1-M9 of the material providing step is supplied to any of the production lines of the first step. A plurality of materials provided in a plurality of production lines of the material providing step may be either supplied to a single production line out of the production lines A1-A10 of the first step or separately supplied to two or more production lines of the first step.

In the same way, each of the plurality of materials processed in the plurality of production lines A1-A10 of the first step is supplied to any of the production lines of the second step. Each of the plurality of materials processed in the plurality of production lines B1-B6 of the second step is supplied to any of the production lines of the third step.

A piece of identification information such as a serial number is assigned to each of the materials. The identification information is assigned to each material at least before the material is supplied to any of the production lines of the first step. The identification information of the material may be either stored in an IC tag attached to the material or inscribed on the material, whichever is appropriate.

The identification information assigned to the material is stored in a database in association with the identification information (such as an identification code) of the production line to which the material is supplied (in other words, the production line on which the operation is currently being performed). If any defective product has been spotted in one process step, the defect prediction system 1 may determine, by reference to the identification information of the defective product, from which of the production lines of the upstream process step the defective product has been supplied.

### (2) Configuration

As shown in FIG. 1, the defect prediction system 1 includes the acquirer 11, the defect-related number predictor 12, the cause predictor 13, a warner 14, a learner 15, and an outputter 16. Note that these constituent elements only represent respective functions to be performed by the defect prediction system 1 and do not always have a substantive physical configuration.

The defect prediction system 1 includes a computer system including one or more processors and a memory. At least some functions of the defect prediction system 1 are performed by making the processor(s) of the computer system execute a program stored in the memory of the computer system. The program may be stored in the memory. The program may also be downloaded via a telecommunications line such as the Internet or distributed after having been stored in a non-transitory storage medium such as a memory card.

In addition, the defect prediction system 1 may also be used along with an inspection system 2 and a presentation device 3.

The inspection system 2 inspects the product for any defects. The inspection system 2 includes a sensor and a decision device. The sensor detects a physical quantity about the product. The decision device determines, based on the physical quantity detected by the sensor, whether the product has any defects or not. It may be determined appropriately based on, for example, a quality control standard of the product what condition of the product is regarded as a defect by the inspection system 2.

The acquirer 11 acquires a past defect-related number of the product from the inspection system 2. For example, the defect prediction system 1 may further include a communications interface device, through which the acquirer 11 acquires the past defect-related number of the product. As used herein, the “past” is a concept that includes a point in time just before the present. For example, a situation where the acquirer 11 acquires the defect-related number in real time from the inspection system 2 may also be hereinafter referred to as acquisition of a “past defect-related number” by the acquirer 11.

The inspection system 2 inspects each product for any defects and provides information about presence or absence of defects to the acquirer 11. The acquirer 11 calculates the aggregate of the information about the presence or absence of defects, thereby obtaining the past defect-related number of the product. Alternatively, the aggregate of the information may also be calculated by the inspection system 2.

In this embodiment, the inspection system 2 inspects the product for any defects in each of the plurality of production lines of the most downstream process step (i.e., the third step). The acquirer 11 acquires the past defect-related number of the product in each of the plurality of production lines of the most downstream process step (i.e., the third step).

The functions of the defect-related number predictor 12 and the cause predictor 13 will be described later.

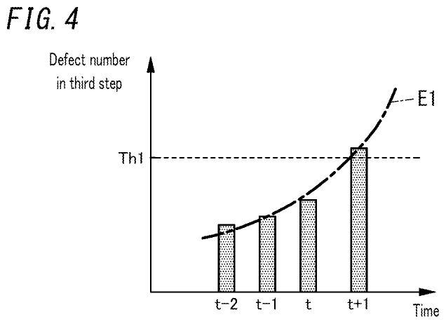

The warner 14 generates, when the total future defect-related number predicted by the defect-related number predictor 12 is equal to or greater than an attention threshold value Th1 (refer to FIG. 4), warning information to call an administrator's attention. The warning information is output by the outputter 16 to the presentation device 3.

The learner 15 generates, by machine learning, a learned model to be used by the defect-related number predictor 12 to predict the future defect-related number. The machine learning will be described in detail later.

The outputter 16 outputs the information to the presentation device 3. The outputter 16 may output the information via the communications interface device, for example.

The presentation device 3 presents the information provided by the outputter 16. The presentation device 3 presents the information as an image, as a sound (including voice), or a combination of an image and a sound. The presentation device 3 according to this embodiment includes a display. The presentation device 3 conducts a display operation in a form corresponding to the information provided by the outputter 16.

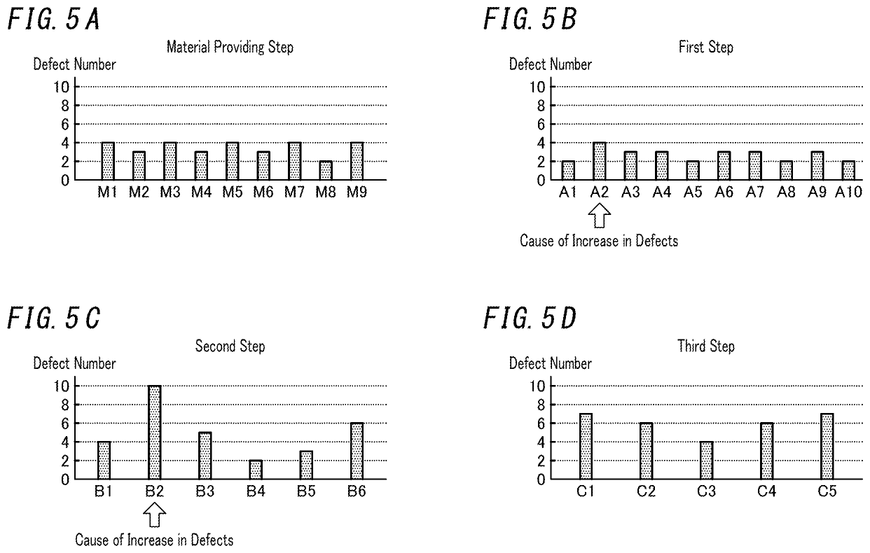

FIGS. 5A-5D show exemplary pieces of information displayed on the presentation device 3. In FIGS. 5A-5D, the future defect-related numbers (numbers of defects) predicted by the defect-related number predictor 12 are displayed. In addition, a production line A2 labeled as “cause of increase in defects” in FIG. 5B and a production line B2 labeled as “cause of increase in defects” in FIG. 5C are production lines predicted by the cause predictor 13 to be the causes of an increase in the total future defect-related number. As can be seen, FIGS. 5A-5D show which of the production lines is predicted to be the cause of an increase in the total future defect-related number.

That is to say, the outputter 16 outputs, to the presentation device 3, at least one (e.g., both in this embodiment) of the information representing the future defect-related number predicted by the defect-related number predictor 12 or the information indicating the production line predicted by the cause predictor 13 to be the cause of an increase in the total future defect-related number.

### (3) Details of Prediction of Defect-Related Number and Prediction of Cause

Next, it will be described how the defect-related number predictor 12 performs the processing of predicting the future defect-related number and how the cause predictor 13 performs the processing of predicting a production line to be the cause of an increase in the total future defect-related number. The defect-related number is supposed to be the number of defects.

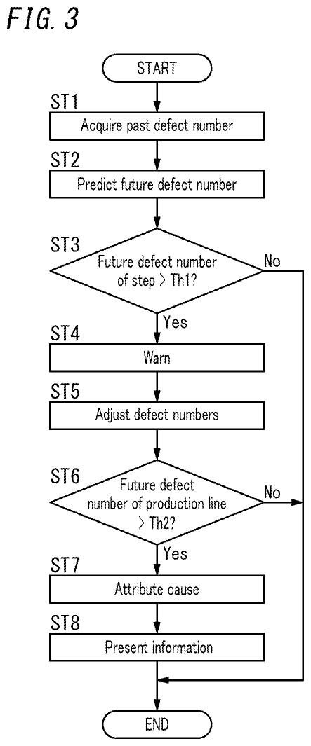

An exemplary flow of the processing to be performed by the defect prediction system 1 is shown in FIG. 3. Note that the flowchart of FIG. 3 shows only an exemplary flow of the processing. Thus, the processing steps shown in FIG. 3 may be performed in a different order as appropriate, an additional processing step may be performed as needed, or at least one of the processing steps may be omitted if unnecessary.

In the third step, the inspection system 2 inspects the product for any defects. The acquirer 11 acquires, from the inspection system 2, a past defect-related number (number of defects) of the product with respect to each of the plurality of production lines C1-C5 of the third step (in Step ST1). More specifically, the acquirer 11 acquires information showing the relationship between the identification information of the production lines and defect-related numbers (numbers of defects) at respective points in time of inspection as shown in the following Table 1:

TABLE 1
Third Step

| Production Line | t − 2 | t − 1 | t |
|---|---|---|---|
| C1 | 3 | 4 | 5 |
| C2 | 4 | 4 | 5 |
| C3 | 4 | 4 | 4 |
| C4 | 4 | 4 | 5 |
| C5 | 3 | 4 | 5 |
| Total | 18 | 20 | 24 |

For example, at an inspection time t, the number of defects of the production line C1 is 5. Also, at the inspection time t, the total number of defects of the production lines C1-C5 is 24.

As used herein, the inspection times t−2, t−1, and t (refer to Table 1 and Tables 2-8 to be posted later) refer to respective points in time at which the product is inspected for any defects in the third step. Tables 1-8 show the correspondence between the respective production lines and the inspection times.

As used herein, if an inspection time corresponding to a particular production line of the material providing step is T (where T=t−2, t−1, t, or t+1), this means that the material is supplied from the particular production line of the material providing step to the first, second, and third steps in this order and then the product is subsequently inspected for any defects at the time T.

If an inspection time corresponding to a particular production line of the first step is T, this means that the material is supplied from the particular production line of the first step to the second and third steps in this order and then the product is subsequently inspected for any defects at the time T.

If an inspection time corresponding to a particular production line of the second step is T, this means that the material is supplied from the particular production line of the second step to the third step and then the product is subsequently inspected for any defects at the time T.

If an inspection time corresponding to a particular production line of the third step is T, this means that the material is supplied to the particular production line of the third step and then the product is subsequently inspected for any defects at the time T.

As used herein, the inspection time t+1 is a point in time in the future, the inspection time t is a point in time closest to the present time, the inspection time t−1 is a point in time preceding the inspection time t, and the inspection time t−2 is a point in time preceding the inspection time t−1.

Also, as used herein, the number of defects corresponding to the inspection time T (where T=t−2, t−1, t, or t+1) refers to the number of defects detected at the inspection time T. Thus, the number of defects corresponding to the inspection time T does not include the number of defects that have been detected before the inspection time T.

Each product (material) is provided with identification information. The acquirer 11 further acquires the identification information of each product. That is to say, the acquirer 11 acquires not only the past defect-related number with respect to each of the plurality of production lines C1-C5 in a particular process step (i.e., the third step) out of the plurality of process steps but also the identification information of the product with respect to each of the plurality of production lines in each of the plurality of process steps.

The defect-related number predictor 12 obtains, by reference to the identification information acquired by the acquirer 11, the past defect-related number with respect to each of the plurality of production lines in a process step upstream of the particular process step. Suppose, for example, a product has been passed through the production line M1 of the material providing step, the production line A3 of the first step, the production line B6 of the second step, and the production line C2 of the third step in this order. In addition, suppose the information acquired by the acquirer 11 reveals that the product has been detected as a defective product in the production line C2 of the third step. In each production line, the processing of storing the identification information of the product (defective product) in a database in association with the identification information of the production line is performed. The defect-related number predictor 12 determines, by reference to the information stored in the database, that the product has been passed through the production line M1 of the material providing step, the production line A3 of the first step, the production line B6 of the second step, and the production line C2 of the third step in this order. The defect-related number predictor 12 inspects every defective product to determine which production line the defective product has been passed through in each process step. In this manner, the relationship between the production lines of each process step and the past defect-related numbers is derived as shown in Table 1 and the following Tables 2-4:

TABLE 2
Material Providing Step

| Production Line | t − 2 | t − 1 | t |
|---|---|---|---|
| M1 | 1 | 2 | 2 |
| M2 | 3 | 3 | 3 |
| M3 | 4 | 3 | 3 |
| M4 | 3 | 4 | 2 |
| M5 | 2 | 2 | 3 |
| M6 | 1 | 2 | 3 |
| M7 | 2 | 2 | 3 |
| M8 | 0 | 0 | 2 |
| M9 | 2 | 2 | 3 |
| Total | 18 | 20 | 24 |

TABLE 3
First Step

| Production Line | t − 2 | t − 1 | t |
|---|---|---|---|
| A1 | 2 | 2 | 2 |
| A2 | 0 | 1 | 3 |
| A3 | 1 | 2 | 2 |
| A4 | 3 | 3 | 3 |
| A5 | 2 | 2 | 2 |
| A6 | 1 | 2 | 2 |
| A7 | 1 | 2 | 2 |
| A8 | 6 | 5 | 4 |
| A9 | 1 | 1 | 2 |
| A10 | 1 | 0 | 2 |
| Total | 18 | 20 | 24 |

TABLE 4
Second Step

| Production Line | t − 2 | t − 1 | 1 |
|---|---|---|---|
| B1 | 4 | 3 | 4 |
| B2 | 6 | 7 | 8 |
| B3 | 1 | 2 | 3 |
| B4 | 2 | 2 | 2 |
| B5 | 3 | 3 | 3 |
| B6 | 2 | 3 | 4 |
| Total | 18 | 20 | 24 |

Tables 2-4 show which of the production lines the product that has turned out, in the third step, to be a defective product has been passed through in process steps upstream of the third step. Therefore, at each point in time, the sum of the defect-related numbers (i.e., the total defect-related number) is constant in each process step. Note that these Tables 1-4 do not directly indicate in which process step the product has turned into a defective product.

The defect-related number predictor 12 predicts, based on the past defect-related number, a future defect-related number (i.e., at the inspection time t+1) with respect to each of the plurality of production lines (in Step ST2). More specifically, the defect-related number predictor 12 predicts the future defect-related number by using a learned model generated by machine learning.

The learned model may include, for example, a classifier that uses a learned neural network. Examples of the learned neural networks may include a convolutional neural network (CNN) and a Bayesian neural network (BNN). The learned model may be implemented by, for example, installing a learned neural network into an integrated circuit such as an application specific integrated circuit (ASIC) or a field-programmable gate array (FPGA).

The learner 15 performs machine learning using the past defect-related number of each production line as training data, thereby generating a learned model. The learned model receives the past defect-related number as input and outputs the future defect-related number.

In this embodiment, the learned model may be, for example, a regression model. That is to say, the defect-related number predictor 12 predicts the future defect-related number by making a regression analysis based on the progress of the past defect-related number. For example, if the learned model is a regression model based on a polynomial, for example, then the learning is the processing of optimizing the coefficients of the polynomial representing the defect-related number. That is to say, a regression equation (e.g., an equation represented by the curve E1 shown in FIG. 4) for calculating the defect-related number is obtained by learning.

The learner 15 generates a learned model suitable for each production line. For example, a learned model for outputting the future defect-related number of the production line C1 of the third step may be different from a learned model for outputting the future defect-related number of each of the production lines C2-C5 and a learned model for outputting the future defect-related number of a production line of any other process step. The learned model for outputting the future defect-related number of the production line C1 of the third step receives, as input, the past defect-related number of the production line C1 and outputs the future defect-related number of the production line C1. In the same way, a learned model associated with a particular production line receives, as input, the past defect-related number of the production line and outputs the future defect-related number of the production line. Optionally, the past defect-related number received as input may be a plurality of defect-related numbers corresponding to a plurality of inspection times in the past. For example, defect-related numbers corresponding to the inspection times t−2, t−1, and t (refer to Tables 1-4), respectively, may be received as inputs.

Examples of the future defect-related numbers (numbers of defects) predicted by the defect-related number predictor 12 are shown in the following Tables 5-8. The data shown in Tables 5, 6, 7, and 8 are generated based on the data shown in Tables 2, 3, 4, and 1, respectively.

TABLE 5
Material Providing Step

| Production Line | t + 1 |
|---|---|
| M1 | 4 |
| M2 | 3 |
| M3 | 4 |
| M4 | 3 |
| M5 | 4 |
| M6 | 3 |
| M7 | 4 |
| M8 | 2 |
| M9 | 4 |
| Total | 31 |

TABLE 6
First Step

| Production Line | t + 1 |
|---|---|
| A1 | 2 |
| A2 | 4 |
| A3 | 3 |
| A4 | 3 |
| A5 | 2 |
| A6 | 3 |
| A7 | 3 |
| A8 | 2 |
| A9 | 3 |
| A10 | 2 |
| Total | 27 |

TABLE 7
Second Step

| Production Line | t + 1 |
|---|---|
| B1 | 4 |
| B2 | 10 |
| B3 | 5 |
| B4 | 2 |
| B5 | 3 |
| B6 | 6 |
| Total | 30 |

TABLE 8
Third Step

| Production Line | t + 1 |
|---|---|
| C1 | 7 |
| C2 | 6 |
| C3 | 4 |
| C4 | 6 |
| C5 | 7 |
| Total | 30 |

The defect-related number predictor 12 compares, with an attention threshold value Th1, the total future defect-related number that has been predicted by the defect-related number predictor 12 with respect to each process step (in Step ST3). If the total future defect-related number is equal to or greater than the attention threshold value Th1 (if the answer is YES in Step ST3), the warner 14 generates warning information to call the administrator's attention (in Step ST4). In this case, the total defect-related number to be compared with the attention threshold value Th1 is the sum of respective defect-related numbers corresponding to a certain inspection time in the future. Referring to Table 8, it can be seen that the total defect-related number (number of defects) corresponding to the inspection time t+1 of the third step is 30.

The total defect-related numbers corresponding to the respective inspection times shown in Tables 1 and 8 with respect to the third step are plotted as a graph in FIG. 4. As shown in FIG. 4, the total defect-related number corresponding to the inspection time t+1 is greater than the attention threshold value Th1. Thus, the defect-related number predictor 12 outputs a result of prediction that multiple defects will be produced. In response, the warner 14 generates warning information and makes the outputter 16 output the warning information to the presentation device 3. The presentation device 3 makes presentation that multiple defects will be produced. For example, the presentation device 3 may display, on a monitor screen, a message that multiple defects will be produced. In addition, the outputter 16 also outputs information about the future defect-related number that has been predicted by the defect-related number predictor 12 to the presentation device 3. The presentation device 3 presents the future defect-related number. For example, the presentation device 3 may display information such as the one shown in Table 8 or FIG. 4.

As shown in Tables 5-8, the total future defect-related numbers are respectively derived for the plurality of process steps. The defect-related number predictor 12 may output, if the total future defect-related number corresponding to at least one process step is greater than the attention threshold value Th1, the result of prediction that multiple defects will be produced.

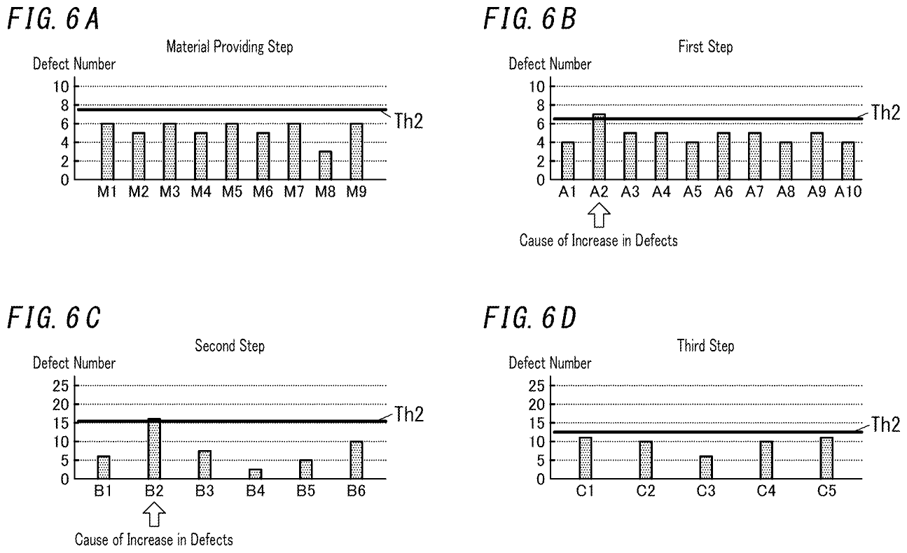

Next, the cause predictor 13 predicts a production line that will be the cause of an increase in the total future defect-related number. Specifically, the cause predictor 13 predicts, a production line, in which the future defect-related number predicted by the defect-related number predictor 12 is equal to or greater than a cause threshold value Th2 (refer to FIGS. 6A-6D) and which belongs to the plurality of production lines, to be the production line that will be the cause of the increase in the total future defect-related number.

The cause predictor 13 determines the cause threshold value Th2 based on the distribution of the future defect-related numbers associated with the respective production lines. More specifically, the cause predictor 13 adjusts, with respect to each of the plurality of process steps, respective future defect numbers (i.e., numbers of future defects) of the plurality of production lines such that the sum of the respective future defect numbers of the plurality of production lines falls within a predetermined range and determines the cause threshold value Th2 based on the distribution of the future defect numbers thus adjusted. In addition, the cause predictor 13 also determines the cause threshold value Th2 based on a quantile of the distribution of the future defect-related numbers associated with the respective production lines. As used herein, to “adjust the defect number” does not mean changing the number of defective products actually manufactured. Rather, to “adjust the defect number” as used herein means regarding, when making calculations to determine the cause threshold value Th2, the defect number as a number larger or smaller than the actual one. This point will be described in detail with reference to the accompanying drawings.

FIGS. 5A-5D are graphs plotted based on the data shown in Tables 5-8, respectively. Specifically, FIGS. 5A-5D show the distribution (predicted value) of the defect numbers corresponding to the inspection time t+1 and associated with the respective production lines. The cause predictor 13 adjusts, with respect to each of the plurality of process steps, respective future defect numbers of the plurality of production lines such that the sum of the respective future defect numbers of the plurality of production lines falls within a predetermined range. Preferably, the cause predictor 13 adjusts, with respect to each of the plurality of process steps, respective future defect numbers of the plurality of production lines such that the sum of the respective future defect numbers of the plurality of production lines will be a predetermined value (in Step ST5). As used herein, the “predetermined value” refers to the sum of the future defect numbers that has been predicted based on the sum of the past defect numbers. For example, the defect-related number predictor 12 predicts the sum of the defect numbers at the inspection time t+1 to be 48 while the respective sums of the defect numbers at the inspection times t−2, t−1, and t are 18, 20, and 24, respectively. The adjustment of the future defect number is made on this defect number of 48. Note that the adjustment is made on the defect number, not on the defect rate. Optionally, a constant value may be used as the predetermined value, instead of the predicted value.

As for the third step, for example, the sum of the future defect numbers of the plurality of production lines C1-C5 is 30. The cause predictor 13 adjusts the defect numbers of the respective production lines C1-C5 of the third step such that the sum of the future defect numbers of the production lines C1-C5 of the third step will be 48. Specifically, the cause predictor 13 adjusts the defect numbers by multiplying the defect number of each of the production lines C1-C5 by 48/30, which is the ratio of 48 to 30 that is the sum of the defect numbers of the third step. In this case, the defect number of each production line is rounded up or down to be an integer. For example, the defect numbers are adjusted such that the magnitude of variation in the coefficient of variation of the defect numbers among the plurality of production lines of a certain process step becomes minimum before and after the defect numbers of the certain process step are adjusted.

As for each of the process steps other than the third step, the cause predictor 13 also adjusts the defect numbers such that the sum of the defect numbers will be 48. The distribution of the defect numbers that have been adjusted in shown in FIGS. 6A-6D and the following Tables 9-12:

TABLE 9
Material Providing Step

| Production Line | Adjusted Number |
|---|---|
| M1 | 6 |
| M2 | 5 |
| M3 | 6 |
| M4 | 5 |
| M5 | 6 |
| M6 | 5 |
| M7 | 6 |
| M8 | 3 |
| M9 | 6 |
| Total | 48 |

TABLE 10
First Step

| Production Line | Adjusted Number |
|---|---|
| A1 | 4 |
| A2 | 7 |
| A3 | 5 |
| A4 | 5 |
| A5 | 4 |
| A6 | 5 |
| A7 | 5 |
| A8 | 4 |
| A9 | 5 |
| A10 | 4 |
| Total | 48 |

TABLE 11
Second Step

| Production Line | Adjusted Number |
|---|---|
| B1 | 6 |
| B2 | 16 |
| B3 | 8 |
| B4 | 3 |
| B5 | 5 |
| B6 | 10 |
| Total | 48 |

TABLE 12
Third Step

| Production Line | Adjusted Number |
|---|---|
| C1 | 11 |
| C2 | 10 |
| C3 | 6 |
| C4 | 10 |
| C5 | 11 |
| Total | 48 |

Next, the cause predictor 13 determines the cause threshold value Th2 based on the distribution of the defect numbers thus adjusted. Specifically, the cause predictor 13 determines the cause threshold value Th2 based on a quartile of the distribution of the defect numbers. The first quartile will be hereinafter designated by Q1, and the third quartile will be hereinafter designated by Q3. Multiple target numerical values are arranged in the descending order and are equally divided into four groups of numerical values. In that case, the first boundary value is the first quartile, and the third boundary value is the third quartile. If a boundary is located between two numerical values, then a weighted average of the two numerical values, which is calculated by adding a weight, corresponding to the distance from the boundary, to each of the two numerical values, is obtained as the first quartile (or the third quartile). The cause predictor 13 determines the cause threshold value Th2 by the following Equation (1):

$$Th 2 = Q 3 + ( Q 3 - Q 1 ) \times 1.5 \qquad ( 1.5 )$$

If this Equation (1) is applied to the distributions shown in FIGS. 6A-6D, the first quartile Q1, the third quartile Q3, and the cause threshold value Th2 corresponding to the material providing step are 5, 6, and 7.5, respectively; the first quartile Q1, the third quartile Q3, and the cause threshold value Th2 corresponding to the first step are 4, 5, and 6.5, respectively; the first quartile Q1, the third quartile Q3, and the cause threshold value Th2 corresponding to the second step are 5.25 (=(5×0.75)+(6×0.25)). 9.5 (=(8×0.25)+(10×0.75)), and 15.875, respectively; and the first quartile Q1, the third quartile Q3, and the cause threshold value Th2 corresponding to the third step are 10, 11, and 12.5, respectively.

The defect number of the production line A2 of the first step and the defect number of the production line B2 of the second step are each greater than their corresponding cause threshold value Th2 (i.e., the answer is YES in Step ST6). Thus, the cause predictor 13 predicts the production lines A2, B2 to be production lines to which the cause of an increase in the future defect number (total defect-related number) is attributable (in Step ST7).

Even if the defect number of every production line is less than the cause threshold value Th2 in one process step unless the defect numbers are adjusted, the defect number of any production line may be greater than the cause threshold value Th2 after the defect numbers are adjusted. Adjusting the defect numbers increases the chances of successfully predicting the production line that will be the cause of an increase in the future defect number.

The outputter 16 outputs, to the presentation device 3, information indicating the production line that has been predicted by the cause predictor 13 to be the cause of the increase in the total future defect-related number. In response, the presentation device 3 presents the information indicating the production line to be the cause of the increase in the total future defect-related number (in Step ST8). In addition, the outputter 16 further outputs information giving grounds on which a predetermined production line has been predicted to be the cause of the increase in the total future defect-related number. In response, the presentation device 3 presents the grounds. For example, the presentation device 3 displays information such as the one shown in FIGS. 5A-6D. FIGS. 6B and 6C indicate that the defect number is predicted to be greater than the cause threshold value Th2 in the production lines A2 and B2. This allows the administrator to recognize that the production lines A2, B2 are the causes of an increase in the total future defect-related number. Also, the results of prediction indicating that the defect numbers predicted for the production lines A2, B2 are greater than the cause threshold value Th2 as shown in FIGS. 6B and 6C are the grounds on which the production lines A2, B2 are predicted to be the causes of an increase in the total future defect-related number.

### (First Variation)

A defect prediction system 1 according to a first variation will be described. In the following description, any constituent element of this first variation, having the same function as a counterpart of the embodiment described above, will be designated by the same reference numeral as that counterpart's, and description thereof will be omitted herein.

In the exemplary embodiment described above, the acquirer 11 acquires the past defect-related numbers with respect to only the third step out of the plurality of process steps. According to this first variation, on the other hand, the acquirer 11 acquires the past defect-related numbers with respect to one or more process steps out of the plurality of process steps. That is to say, the inspection system 2 inspects the product for any defects in one or more of the plurality of process steps.

For example, the acquirer 11 acquires the past defect-related number with respect to each of the plurality of production lines of the second step. The defect-related number predictor 12 may predict, based on the progress of the past defect-related numbers in the respective production lines of the second step, the future defect-related numbers with respect to the respective production lines of the second step. The defect-related number predictor 12 may make the prediction by regression analysis, for example.

Furthermore, the defect-related number predictor 12 may derive, by reference to the identification information acquired by the acquirer 11, the past defect-related number with respect to each of the plurality of production lines in the process steps (i.e., the material providing step and the first step) upstream of the second step.

In addition, the acquirer 11 also acquires the past defect-related number with respect to each of the plurality of production lines of the first step, for example. The defect-related number predictor 12 may predict, based on the progress of the past defect-related numbers in the respective production lines of the first step, the future defect-related numbers with respect to the respective production lines of the first step. The defect-related number predictor 12 may make the prediction by regression analysis, for example.

Furthermore, the defect-related number predictor 12 may derive, by reference to the identification information acquired by the acquirer 11, the past defect-related number with respect to each of the plurality of production lines in a process step (i.e., the material providing step) upstream of the first step.

In addition, the acquirer 11 also acquires the past defect-related number with respect to each of the plurality of production lines of the material providing step, for example. The defect-related number predictor 12 may predict, based on the progress of the past defect-related numbers in the respective production lines of the material providing step, the future defect-related numbers with respect to the respective production lines of the material providing step. The defect-related number predictor 12 may make the prediction by regression analysis, for example.

### Other Variations of Exemplary Embodiment

Next, other variations of the exemplary embodiment will be enumerated one after another. Optionally, the variations to be described below may be adopted in combination as appropriate. Alternatively, the variations to be described below may also be adopted in combination with the first variation as appropriate.

The defect-related number predictor 12 may count only products with a particular type of defect among the number of defects. For example, if the types of defects that may be produced to products include a first type of defect and a second type of defect, then the defect-related number predictor 12 may predict the number of the first type of defects to be produced in the future or the number of the second type of defects to be produced in the future, whichever is appropriate. Alternatively, the defect-related number predictor 12 may separately predict the number of the first type of defects to be produced in the future and the number of the second type of defects to be produced in the future. Furthermore, the cause predictor 13 may also separately predict the cause of an increase in the number of first type of defects to be produced in the future and the cause of an increase in the number of second type of defects to be produced in the future.

At least some of the process steps for manufacturing products may include operations to be performed by a worker. That is to say, a system for performing at least some of the process steps may be a system involving the worker.

There may be additional process step(s) downstream of the third step.

The plurality of process steps may include at least the first step and the second step or the material providing step. The first step and the second step are process steps of performing operations to manufacture products. The material providing step is a process step of providing a material for products.

The learned model to be used by the defect-related number predictor 12 does not have to be generated by the learner 15 but may be generated by an external device outside of the defect prediction system 1 and provided for the defect prediction system 1.

The defect-related number predictor 12 may predict the future defect-related number using an algorithm generated without machine learning. For example, a plurality of regression equations for predicting the future defect-related number may be stored in a memory of the defect prediction system 1 and a regression equation for use to predict the future defect-related number may be selected from the plurality of regression equations.

In the exemplary embodiment described above, the defect-related number predictor 12 predicts only defect-related numbers corresponding to a single inspection time t+1. Alternatively, the defect-related number predictor 12 may predict defect-related numbers corresponding to multiple inspection times.

If there are multiple production lines, of which the defect-related numbers are greater than the cause threshold value Th2, then the cause predictor 13 may determine either only a production line with the largest defect-related number to be the cause of an increase in the total defect-related number or all production lines, of which the defect-related numbers are greater than the cause threshold value Th2, to be the causes of the increase in the total defect-related number.

When a defect-related number is compared with a threshold value, the threshold value may be made proportional to the number of products. The number of products is the sum of the number of defective products and the number of non-defective products.

Various configurations (including variations) of the defect prediction system 1 according to the exemplary embodiment described above may also be implemented as a defect prediction method, a (computer) program, or a non-transitory storage medium on which a program is stored.

A defect prediction method according to an aspect is a method for making prediction about defects that a product to be manufactured through a plurality of process steps is going to produce. Each of the plurality of process steps includes a plurality of production lines which are parallel with each other. The defect prediction method includes an acquisition step, a defect-related number prediction step, and a cause prediction step. The acquisition step includes acquiring a past defect-related number with respect to each of the plurality of production lines in at least one of the plurality of process steps. The past defect-related number is related to a number of defects produced in the past to the product. The defect-related number prediction step includes predicting, based on the past defect-related number acquired in the acquisition step, a future defect-related number with respect to each of the plurality of production lines in each of the plurality of process steps. The future defect-related number is related to a number of defects that are predicted to be produced in the future to the product. The cause prediction step includes predicting, based on the future defect-related number predicted in the defect-related number prediction step with respect to each of the plurality of production lines in each of the plurality of process steps, which of the plurality of production lines a cause of an increase in a total future defect-related number is attributable to. The total future defect-related number is a sum of the respective future defect-related numbers of the plurality of production lines.

A program according to another aspect is designed to cause one or more processors of a computer system to perform the defect prediction method described above. The program may be stored in a computer-readable non-transitory storage medium.

The defect prediction system 1 according to the present disclosure includes a computer system. The computer system may include a processor and a memory as principal hardware components thereof. At least one some functions of the defect prediction system 1 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of functions of the defect prediction system 1 are aggregated together in a single device. However, this is not an essential configuration for the defect prediction system 1. Alternatively, the respective constituent elements of the defect prediction system 1 may be distributed in multiple different devices. Still alternatively, at least some functions of the defect prediction system 1 (e.g., the function of at least one of the defect-related number predictor 12 or the cause predictor 13) may be implemented as a cloud computing system as well.

Conversely, the plurality of functions distributed in multiple devices in the exemplary embodiment described above may be aggregated together in a single device. For example, the defect prediction system 1 and the presentation device 3 may be aggregated together in a single device.

Furthermore, in the foregoing description of embodiments, if one of two values being compared with each other is “equal to or greater than” the other, this phrase may herein cover both a situation where these two values are equal to each other and a situation where one of the two values is greater than the other. However, this should not be construed as limiting. Alternatively, the phrase “equal to or greater than” may also be a synonym of the phrase “greater than” that covers only a situation where one of the two values is over the other. That is to say, it is arbitrarily changeable, depending on selection of a reference value or any preset value, whether or not the phrase “equal to or greater than” covers the situation where the two values are equal to each other. Therefore, from a technical point of view, there is no difference between the phrase “equal to or greater than” and the phrase “greater than.” Similarly, the phrase “equal to or less than” may be a synonym of the phrase “less than” as well.

### (Recapitulation)

The exemplary embodiment and its variations described above are specific implementations of the following aspects of the present disclosure.

A defect prediction system (1) according to a first aspect makes prediction about defects that a product to be manufactured through a plurality of process steps is going to produce. Each of the plurality of process steps includes a plurality of production lines which are parallel with each other. The defect prediction system (1) includes an acquirer (11), a defect-related number predictor (12), and a cause predictor (13). The acquirer (11) acquires a past defect-related number with respect to each of the plurality of production lines in at least one of the plurality of process steps. The past defect-related number is related to a number of defects produced in the past to the product. The defect-related number predictor (12) predicts, based on the past defect-related number acquired by the acquirer (11), a future defect-related number with respect to each of the plurality of production lines in each of the plurality of process steps. The future defect-related number is related to a future defect number that is a number of defects predicted to be produced in the future to the product. The cause predictor (13) predicts, based on the future defect-related number predicted by the defect-related number predictor (12) with respect to each of the plurality of production lines in each of the plurality of process steps, which of the plurality of production lines a cause of an increase in a total future defect-related number is attributable to. The total future defect-related number is a sum of the respective future defect-related numbers of the plurality of production lines.

This configuration enables determining (predicting) the cause of an increase in a total defect-related number of products before the total defect-related number increases. This contributes to cutting down the total defect-related number of the products by eliminating the cause on an early stage.

A defect prediction system (1) according to a second aspect, which may be implemented in conjunction with the first aspect, further includes a warner (14). The warner (14) generates, when the total future defect-related number predicted by the defect-related number predictor (12) is equal to or greater than an attention threshold value (Th1), warning information to call an administrator's attention.

This configuration allows the administrator to recognize that an increase in the total future defect-related number of the products is predicted.

Ina defect prediction system (1) according to a third aspect, which may be implemented in conjunction with the first or second aspect, the acquirer (11) acquires: the past defect-related number with respect to each of the plurality of production lines in a particular process step belonging to the plurality of process steps; and identification information of the product with respect to each of the plurality of production lines in each of the plurality of process steps. The defect-related number predictor (12) derives, by reference to the identification information acquired by the acquirer (11), the past defect-related number with respect to each of the plurality of production lines in a process step upstream of the particular process step.

This configuration allows the defect-related number predictor (12) to derive the past defect-related number with respect to a process step upstream of the particular process step and thereby predict a future defect-related number based on the past defect-related number.

In a defect prediction system (1) according to a fourth aspect, which may be implemented in conjunction with any one of the first to third aspects, the cause predictor (13) predicts a production line, in which the future defect-related number predicted by the defect-related number predictor (12) is equal to or greater than a cause threshold value (Th2) and which belongs to the plurality of production lines, to be the production line to which the cause of the increase in the total future defect-related number is attributable.

This configuration allows a production line, of which the defect-related number will be relatively large among the plurality of production lines, to be determined as the cause of the increase in the total future defect-related number.

In a defect prediction system (1) according to a fifth aspect, which may be implemented in conjunction with the fourth aspect, the cause predictor (13) determines the cause threshold value (Th2) based on a distribution of the future defect-related numbers associated with the respective production lines.

This configuration allows the cause threshold value (Th2) to be determined automatically.

In a defect prediction system (1) according to a sixth aspect, which may be implemented in conjunction with the fifth aspect, the cause predictor (13) adjusts, with respect to each of the plurality of process steps, a plurality of the future defect numbers of the plurality of production lines such that a sum of the plurality of the future defect numbers of the plurality of production lines falls within a predetermined range and determines the cause threshold value (Th2) based on a distribution of the plurality of the future defect numbers thus adjusted.

This configuration increases the chances of successfully predicting, by adjusting the defect numbers, a production line, to which the cause of an increase in the future defect number (total defect-related number) is attributable.

In a defect prediction system (1) according to a seventh aspect, which may be implemented in conjunction with the fifth or sixth aspect, the cause predictor (13) determines the cause threshold value (Th2) based on a quantile of the distribution of the plurality of the future defect numbers associated with the respective production lines.

This configuration allows the cause threshold value (Th2) to be determined automatically.

In a defect prediction system (1) according to an eighth aspect, which may be implemented in conjunction with any one of the first to seventh aspects, the defect-related number predictor (12) predicts the future defect-related number by making a regression analysis based on a progress of the past defect-related number.

This configuration enables predicting the future defect-related number.

In a defect prediction system (1) according to a ninth aspect, which may be implemented in conjunction with any one of the first to eighth aspects, the defect-related number predictor (12) predicts the future defect-related number by using a learned model generated by machine learning.

This configuration contributes to improving the accuracy of predicting the future defect-related number.

A defect prediction system (1) according to a tenth aspect, which may be implemented in conjunction with any one of the first to ninth aspects, further includes an outputter (16). The outputter outputs information to a presentation device (3). The presentation device (3) presents the information provided by the outputter (16).

This configuration allows the information generated by the defect prediction system (1) to be presented to an administrator, for example.

In a defect prediction system (1) according to an eleventh aspect, which may be implemented in conjunction with the tenth aspect, the outputter (16) outputs, to the presentation device (3), at least one of information representing the future defect-related number predicted by the defect-related number predictor (12) or information indicating the production line that has been predicted by the cause predictor (13) to be the cause of the increase in the total future defect-related number.

This configuration allows the information generated by the defect prediction system (1) to be presented to an administrator, for example.

Ina defect prediction system (1) according to a twelfth aspect, which may be implemented in conjunction with the eleventh aspect, the outputter (16) further outputs information giving grounds on which a predetermined one of the plurality of production lines has been predicted to be the cause of the increase in the total future defect-related number.

This configuration allows the cause of the increase in the total future defect-related number to be presented to an administrator, for example.

Note that the constituent elements according to the second to twelfth aspects are not essential constituent elements for the defect prediction system (1) but may be omitted as appropriate.

A defect prediction method according to a thirteenth aspect is a method for making prediction about defects that a product to be manufactured through a plurality of process steps is going to produce. Each of the plurality of process steps includes a plurality of production lines which are parallel with each other. The defect prediction method includes an acquisition step, a defect-related number prediction step, and a cause prediction step. The acquisition step includes acquiring a past defect-related number with respect to each of the plurality of production lines in at least one of the plurality of process steps. The past defect-related number is related to a number of defects produced in the past to the product. The defect-related number prediction step includes predicting, based on the past defect-related number acquired in the acquisition step, a future defect-related number with respect to each of the plurality of production lines in each of the plurality of process steps. The future defect-related number is related to a future defect number that is a number of defects predicted to be produced in the future to the product. The cause prediction step includes predicting, based on the future defect-related number predicted in the defect-related number prediction step with respect to each of the plurality of production lines in each of the plurality of process steps, which of the plurality of production lines a cause of an increase in a total future defect-related number is attributable to. The total future defect-related number is a sum of the respective future defect-related numbers of the plurality of production lines.

This method enables determining (predicting) the cause of an increase in a total defect-related number of products before the total defect-related number increases. This contributes to cutting down the total defect-related number of the products by eliminating the cause on an early stage.

A program according to a fourteenth aspect is designed to cause one or more processors of a computer system to perform the defect prediction method according to the thirteenth aspect.

This program enables determining (predicting) the cause of an increase in a total defect-related number of products before the total defect-related number increases. This contributes to cutting down the total defect-related number of the products by eliminating the cause on an early stage.

### REFERENCE SIGNS LIST

1 Defect Prediction System
3 Presentation Device
11 Acquirer
12 Defect-Related Number Predictor
13 Cause Predictor
16 Outputter
Th1 Attention Threshold Value
Th2 Cause Threshold Value

1. A defect prediction system configured to make prediction about defects that a product to be manufactured through a plurality of process steps is going to produce,
each of the plurality of process steps including a plurality of production lines which are parallel with each other,
the defect prediction system comprising:
an acquirer configured to acquire a past defect-related number with respect to each of the plurality of production lines in at least one of the plurality of process steps, the past defect-related number being related to a number of defects produced in the past to the product;
a defect-related number predictor configured to predict, based on the past defect-related number acquired by the acquirer, a future defect-related number with respect to each of the plurality of production lines in each of the plurality of process steps, the future defect-related number being related to a future defect number that is a number of defects predicted to be produced in the future to the product; and
a cause predictor configured to predict, based on the future defect-related number predicted by the defect-related number predictor with respect to each of the plurality of production lines in each of the plurality of process steps, which of the plurality of production lines a cause of an increase in a total future defect-related number is attributable to, the total future defect-related number being a sum of the respective future defect-related numbers of the plurality of production lines.

2. The defect prediction system of claim 1, further comprising a warner configured to, when the total future defect-related number predicted by the defect-related number predictor is equal to or greater than an attention threshold value, generate warning information to call an administrator's attention.

3. The defect prediction system of claim 1, wherein
the acquirer is configured to acquire:
the past defect-related number with respect to each of the plurality of production lines in a particular process step belonging to the plurality of process steps; and
identification information of the product with respect to each of the plurality of production lines in each of the plurality of process steps, and
the defect-related number predictor is configured to derive, by reference to the identification information acquired by the acquirer, the past defect-related number with respect to each of the plurality of production lines in a process step upstream of the particular process step.

4. The defect prediction system of claim 1, wherein
the cause predictor is configured to predict a production line, in which the future defect-related number predicted by the defect-related number predictor is equal to or greater than a cause threshold value and which belongs to the plurality of production lines, to be the production line to which the cause of the increase in the total future defect-related number is attributable.

5. The defect prediction system of claim 4, wherein
the cause predictor is configured to determine the cause threshold value based on a distribution of the future defect-related numbers associated with the respective production lines.

6. The defect prediction system of claim 5, wherein
the cause predictor is configured to adjust, with respect to each of the plurality of process steps, a plurality of the future defect numbers of the plurality of production lines such that a sum of the plurality of the future defect numbers of the plurality of production lines falls within a predetermined range and to determine the cause threshold value based on a distribution of the plurality of the future defect numbers thus adjusted.

7. The defect prediction system of claim 5, wherein
the cause predictor is configured to determine the cause threshold value based on a quantile of the distribution of the plurality of the future defect numbers associated with the respective production lines.

8. The defect prediction system of claim 1, wherein
the defect-related number predictor is configured to predict the future defect-related number by making a regression analysis based on a progress of the past defect-related number.

9. The defect prediction system of claim 1, wherein
the defect-related number predictor is configured to predict the future defect-related number by using a learned model generated by machine learning.

10. The defect prediction system of claim 1, further comprising an outputter configured to output information to a presentation device, wherein
the presentation device is configured to present the information provided by the outputter.

11. The defect prediction system of claim 10, wherein
the outputter is configured to output, to the presentation device, at least one of information representing the future defect-related number predicted by the defect-related number predictor or information indicating the production line that has been predicted by the cause predictor to be the cause of the increase in the total future defect-related number.

12. The defect prediction system of claim 11, wherein
the outputter is configured to further output information giving grounds on which a predetermined one of the plurality of production lines has been predicted to be the cause of the increase in the total future defect-related number.

13. A defect prediction method for making prediction about defects that a product to be manufactured through a plurality of process steps is going to produce,
each of the plurality of process steps including a plurality of production lines which are parallel with each other,
the defect prediction method comprising:
an acquisition step including acquiring a past defect-related number with respect to each of the plurality of production lines in at least one of the plurality of process steps, the past defect-related number being related to a number of defects produced in the past to the product;
a defect-related number prediction step including predicting, based on the past defect-related number acquired in the acquisition step, a future defect-related number with respect to each of the plurality of production lines in each of the plurality of process steps, the future defect-related number being related to a future defect number that is a number of defects predicted to be produced in the future to the product; and
a cause prediction step including predicting, based on the future defect-related number predicted in the defect-related number prediction step with respect to each of the plurality of production lines in each of the plurality of process steps, which of the plurality of production lines a cause of an increase in a total future defect-related number is attributable to, the total future defect-related number being a sum of the respective future defect-related numbers of the plurality of production lines.

14. A non-transitory computer-readable storage medium storing a computer program designed to cause one or more processors of a computer system to perform the defect prediction method of claim 13.
